(19) United States
(12) Patent Application Publication
(10) Pub. No.: US 2008/0304589 A1
(43) Pub. Date: Dec. 11, 2008

(54) WIRELESS RECEIVER, METHOD FOR CONTROLLING THE WIRELESS RECEIVER, PROGRAM FOR CONTROLLING THE WIRELESS RECEIVER, AND SEMICONDUCTOR INTEGRATED CIRCUIT

(75) Inventors: Makoto Tsuruta, Kawasaki-shi (JP); Jun Mitsugi, Yokohama-shi (JP); Hidehiro Matsuoka, Yokohama-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 12/052,171

(22) Filed: Mar. 20, 2008

(30) Foreign Application Priority Data
Jun. 5, 2007 (JP) 2007-149784

(51) Int. Cl. H04L 27/28; H04B 1/10

(52) U.S. Cl. 375/260; 375/348

(57) ABSTRACT

According to an embodiment of the invention, a wireless receiving apparatus includes: an antenna that receives an OFDM signal having an OFDM symbol and a guard interval; a front end section that performs frequency conversion and synchronization on the received OFDM signal; an ISI canceller that extracts a delay profile and removes leakage of the guard interval into the OFDM symbol by the use of the delay profile; a converter that performs orthogonal conversion on the ISI removed OFDM signal; an equalization section that performs equalization processing on the converted OFDM signal; an outer decoder that decodes the equalized OFDM signal; and an inner decoder that corrects an error in an inner code of the decoded OFDM signal, wherein the equalization section performs re-equalization processing on the converted OFDM signal by using a signal output from the inner decoder as the reference signal.

### CROSS-REFERENCE TO RELATED APPLICATIONS

This application is based upon and claims the benefit of priority from Japanese Patent Application No. 2007-149784, filed Jun. 5, 2007, the entire contents of which are incorporated herein by reference.

### BACKGROUND OF THE INVENTION

1. Field

The present invention relates to a wireless receiver, a method for controlling the wireless receiver, a program for controlling the wireless receiver, and a semiconductor integrated circuit.

2. Related Art

OFDM (Orthogonal Frequency Division Multiplexing) is a digital modulation scheme used for a wireless LAN, digital terrestrial television broadcasting, WiMAX (Worldwide Interoperability for Microwave Access), and the like. In order to mitigate influence of a multipath distortion induced by receipt of radio waves reflected from obstacles from a plurality of propagation paths, an OFDM signal is transmitted while a guard interval is inserted. The OFDM signal is cyclically extended from the original signal of OFDM symbol period Ts by a guard interval of length. However we consider that general guard interval is replaced by unique word. The unique word; for example, a PN (Pseudorandom Noise) Sequence corresponding to a pseudorandom sequence which is one of spread codes is used as the guard interval. A characteristic for synchronization between a time and a frequency is enhanced by application of the PN sequence to the guard interval.

A method by means of which a terminal for receiving an OFDM signal estimates a propagation channel by use of PN correlation in a system using a PN sequence as a unique word has already been reported (see; for example, Non-Patent Document, Z. Yang, J. Wang, M. Han, C. Pan, Lin, Yang, and Zhouan: “Channel Estimation of DMB-T,” Circuits and Systems and West Sino Expositions, IEEE 2002, International Conference, 29 Jun. to 1 Jul. 2002, pp. 1069 to 1072, vol. 2)

According to a technique described in the above Non-Patent Document, for a system using a unique word for a guard interval, it is difficult to accurately estimate a propagation channel except that the system is in a propagation environment where a multipath propagation environment, such as an NLOS (Non-Line Of Sight), from a transmission station to a receiving station, is acquired. Therefore, the technique presents a drawback of a failure to sufficiently reduce a bit error rate of a received signal, to thus deteriorate receiving quality.

### SUMMARY OF THE INVENTION

According to one embodiment of the present invention, there is provided a wireless receiving apparatus including an antenna that receives an OFDM (Orthogonal Frequency Division Multiplexing) signal transmitted from a wireless transmitter, the OFDM signal having an OFDM symbol and a guard interval; a front end section that performs frequency conversion, BPF or LPF and synchronization on the received OFDM signal; an ISI (Inter-Symbol Interference) canceller that extracts a delay profile from a signal output from the front end section and removes leakage of the guard interval into the OFDM symbol from the signal output from the front end section by the use of the delay profile; a converter that performs orthogonal conversion on the ISI removed OFDM signal; an equalization section that performs equalization processing on the converted OFDM signal by estimating a state of a propagation channel from a reference signal and the delay profile; n outer decoder that decodes the equalized OFDM signal; and an inner decoder that corrects an error in an inner code of the decoded OFDM signal, herein the equalization section performs re-equalization processing on the converted OFDM signal by using a signal output from the inner decoder as the reference signal.

According to another embodiment of the present invention, there is provided a method for controlling a wireless receiver including: receiving an OFDM (Orthogonal Frequency Division Multiplexing) signal, the OFDM signal having an OFDM symbol and a guard interval; performing frequency conversion and synchronization on the received OFDM signal; extracting a delay profile from a signal obtained by frequency conversion and synchronization; removing leakage of the guard interval into the OFDM symbol from the signal obtained by frequency conversion and synchronization by the use of the delay profile; performing orthogonal conversion on the leakage removed OFDM signal; performing equalization processing on the orthogonal converted OFDM signal by estimating a state of a propagation channel from a reference signal and the delay profile; decoding the equalized OFDM signal; correcting an error in an inner code of the decoded OFDM signal; and performing re-equalization processing on the converted OFDM signal by using the corrected ODFM signal as the reference signal.

### BRIEF DESCRIPTION OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block diagram showing an OFDM receiver 1 of a first embodiment;

FIG. 2 shows the configuration of the OFDM signal of the first embodiment;

FIG. 3 is a model chart showing ISI removal processing of the first embodiment;

FIG. 4 is a view showing an overlap between an ISI-canceled advancing wave and a delayed wave;

FIG. 5 is a view showing a bit error rate acquired after demodulation and decoding operations of the OFDM receiver of the first embodiment;

FIG. 6 is a flowchart showing a method for determining convergence of the bit error rate performed by an iterative control section of the first embodiment;

FIG. 7 is a block diagram showing the configuration of an ISI canceller and the configuration of an equalization processing section of the first embodiment;

FIG. 8 is a flowchart showing operation of the ISI canceller of the first embodiment;

FIG. 9 is a flowchart showing operation of the equalization processing section of the first embodiment;

FIG. 10 is a block diagram showing the configuration of an OFDM receiver of a second embodiment;

FIG. 11 is a block diagram showing the configuration of an OFDM receiver of a third embodiment;

FIG. 12 is a block diagram showing the configuration of an OFDM receiver of a fourth embodiment; and

FIG. 13 is a block diagram showing the configuration of a combination section of the fourth embodiment.

### DETAILED DESCRIPTION OF THE INVENTION

Embodiments of the present invention will be described hereunder.

### First Embodiment

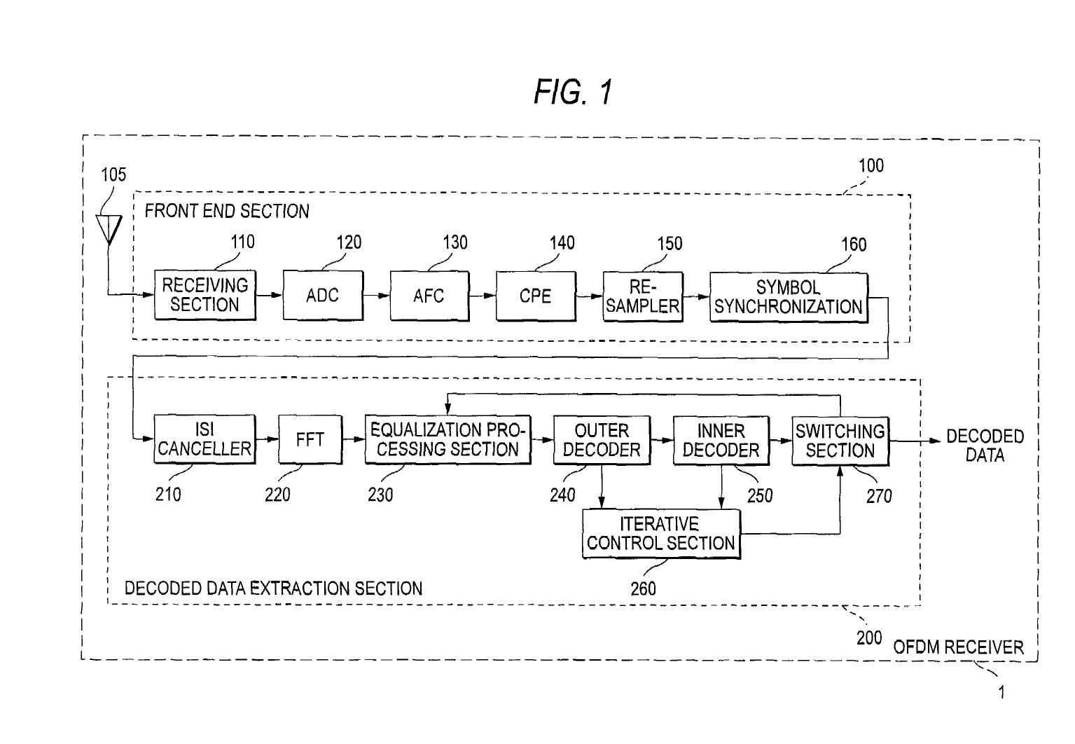

FIG. 1 is a block diagram showing an OFDM receiver 1 of a first embodiment of the present invention.

The OFDM receiver 1 of the first embodiment has an antenna 105 for receiving an OFDM signal transmitted from a transmission station (not shown); a front end section 100 for synchronizing an OFDM receipt signal received by the antenna 105 and an OFDM transmission signal transmitted from the transmission station; and a decoded data extraction section 200 for extracting decoded data from the OFDM signal received from the front end section 100.

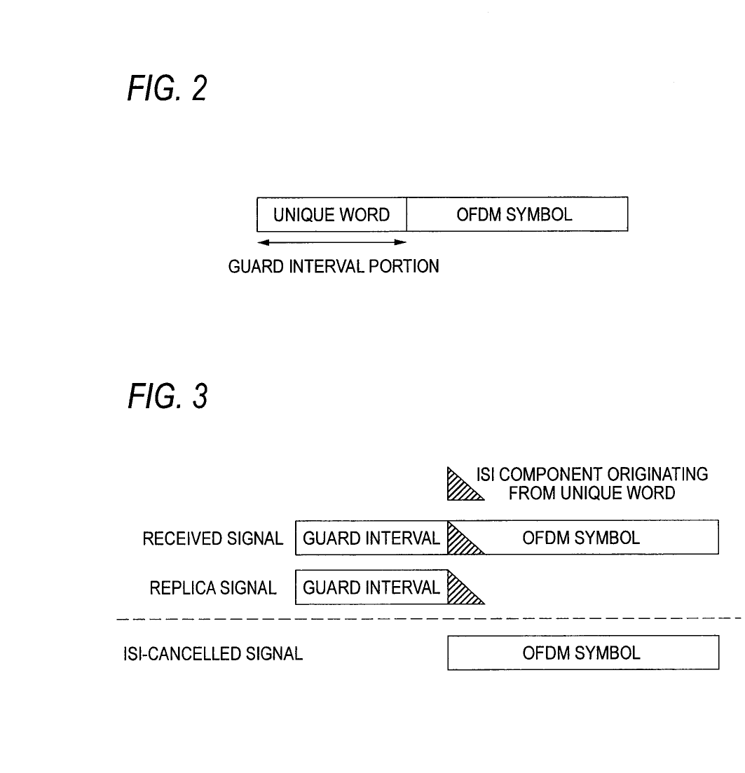

FIG. 2 shows the configuration of the OFDM signal.

A frame format of the OFDM signal is formed from an OFDM symbol serving as a data section to be transmitted and a guard interval section into which a unique word is written. The essential requirement for the unique word is a small cross correlation with the OFDM symbol. In the present embodiment, the unique word is described as a PN sequence corresponding to a pseudorandom sequence which is one of spread codes.

After being parallelly converted into a plurality of sub-carriers, the OFDM signal undergoes IFFT (Inverse Fast Fourier Transformation), and the thus-transformed signal is transmitted. Specifically, signals are caused to overlap each other along a frequency axis by utilization of orthogonality, thereby densely arranging a plurality of sub-carriers, and the signal is transmitted.

The antenna 105 receives an OFDM signal from the transmission station. There is a case where a propagation environment existing between the transmission station and the antenna 105 is a propagation environment where a sight line, such as an LOS, from a transmission station to a receiving station is achieved. However, there also arises a propagation environment where no sight line, such as an NLOS, from a transmission station to a receiving station is achieved under the influence of an obstacle or the like.

The front end section 100 is formed from a receiving section 110, an ADC (Analogue-to-Digital Converter) 120; an AFC (Automatic Frequency Control) 130; a CPE (Common Phase Error) 140; a re-sampler 150; and a symbol synchronization section 160.

The receiving section 110 has a low-noise amplifier (not shown) for amplifying the OFDM signal received from the antenna 105; a frequency converter (not shown) for converting the amplified signal into a frequency; and a filter (not shown) for extracting a specific frequency band from the frequency-converted signal.

The ADC 120 converts, into a digital signal, an analogue signal converted by the received section 110 to a frequency suitable for computation. In order to perform digital signal processing performed by the AFC 130 and subsequent sections, the ADC 120 converts an analogue signal into a digital signal.

The AFC 130 adjusts the frequency of the signal output from the ADC 120 so as to match the frequency of the OFDM transmission signal transmitted from the transmission station. The CPE 140 adjusts phase fluctuations in the signal output from the AFC 130.

The re-sampler 150 adjusts a sampling rate in such a way that a sampling rate of a signal output from the CPE 140 becomes identical with a sampling rate of the OFDM transmission signal transmitted by the transmission station.

The symbol synchronization section 160 detects a guard interval portion of the signal received from the re-sampler 150. As a result, an OFDM symbol portion corresponding to the data portion transmitted from the transmission station is extracted.

The decoded data extraction section 200 is composed of an ISI (Inter-symbol Interference) canceller 210, an FFT (Fast-Fourier Transform) 220, an equalization processing section 230, an outer decoder 240, an inner decoder 250, an iterative control section 260, and a switching section 270.

The ISI canceller 210 eliminates inter-symbol interference (ISI) from the signal received from the symbol synchronization section 160 of the front end section 100. ISI is caused by leakage of the guard interval into the OFDM symbol. Specifically, ISI arises when the signal transmitted from the transmission station is received by the OFDM receiver 1 in the propagation environment where a sight line from the transmission station to the OFDM receiver 1 is not achieved.

FIG. 3 shows a model chart of a specific method by means of which the ISI canceller 210 eliminates ISI when a multipath is assumed as a propagation channel. The ISI canceller 210 generates a replica signal by means of convolution of a delay profile extracted from the signal output from the symbol synchronization section 160 and a transmitted guard interval signal.

The ISI canceller 210 subtracts the generated replica signal from the signal received from the symbol synchronization section 160 of the front end section 100, to thus eliminate the guard interval portion. Thus, the ISI canceller 210 eliminates ISI. A method by means of which the ISI canceller 210 eliminates ISI will be described in detail later.

The FFT 220 subjects, to fast Fourier transformation, the signal from which ISI is eliminated by the ISI canceller 210, and collectively demodulates the transformed signal. The signal from which ISI is eliminated by the ISI canceller 210 is decomposed into sub-carriers. The FFT 220 may also perform orthogonal transform; for example, discrete sine transform, discrete cosine transform, wavelet, and the like, according to a scheme for transmitting and receiving the OFDM signal.

The equalization processing section 230 eliminates, from the signal received from the FFT 220, distortion induced by ICI (inter-carrier interference)—which develops as a result of the guard interval portion being eliminated by the ISI canceller 210—or by the propagation channel.

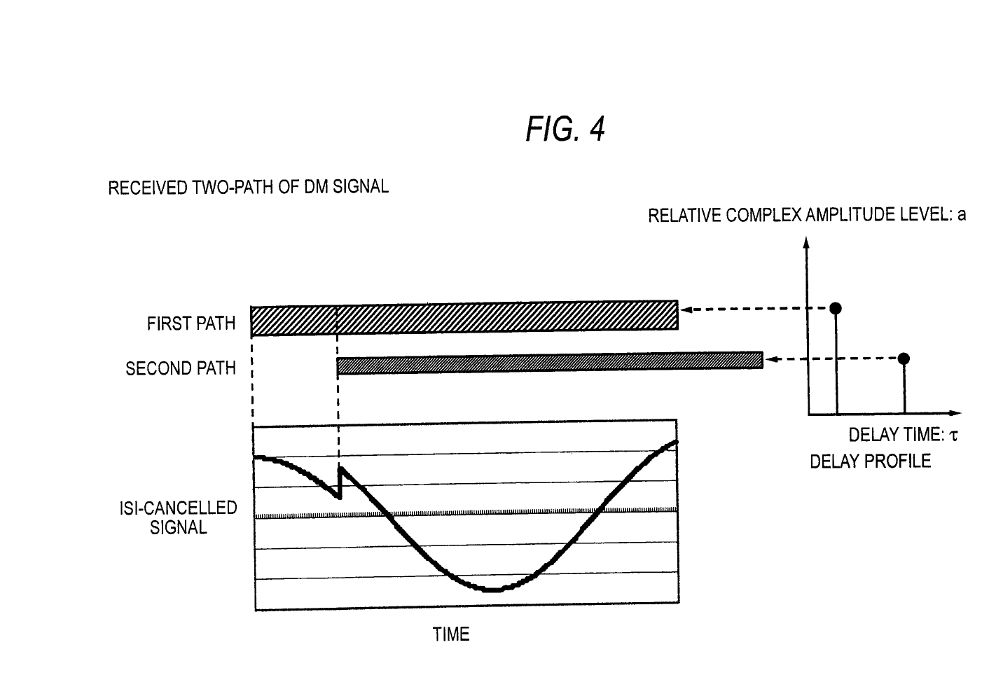

FIG. 4 shows a signal obtained by superposing an advancing wave (a sinusoidal wave) of first path from which ISI is eliminated on a delayed wave (a sinusoidal wave) of second path. Since the guard interval portion has been eliminated, the signal obtained by superposing the advancing wave on the delayed wave turns into a discontinuous signal. The discontinuous signal affects other sub-carriers, thereby inducing ICI.

The equalization processing section 230 eliminates an OFDM symbol from the delayed wave, thereby eliminating the discontinuous portion; i.e., ICI. ICI referred to herein is directed to ICI which develops as a result of elimination of the guard interval portion. However, the equalization processing section also address ICI which develops for another reason, such as the Doppler effect.

In order to eliminate the OFDM symbol from the delayed wave, the equalization processing section 230 must compute a lag time between the delayed wave and the advancing wave and the intensity and phase of the delayed wave relative to the advancing wave. The lag time between the delayed wave and the advancing wave and the intensity and phase of the delayed wave relative to the advancing wave are dependent on the status of a propagation channel between the transmission station and the OFDM receiver 1.

Therefore, the equalization processing section 230 eliminates ICI which develops as a result of elimination of the guard interval portion. In order to compensate for distortion of the propagation channel, the status of the propagation channel must be accurately estimated.

The equalization processing section 230 estimates an accurate propagation channel from limited information and performs ZF (Zero Forcing) equalization processing, MMSE (Minimum Mean Square Error) equalization processing, and the like, from the information, thereby eliminating distortion stemming from ICI and the propagation channel. A method for estimating the status of the propagation channel and the method by means of which the equalization processing section 230 eliminates ICI will be described in detail later.

The outer decoder 240 subjects the signal received from the equalization processing section 230 to soft determination decoding or hard determination decoding with respect to the sub-carrier by means of, as one example, a Viterbi decoding method. Hard determination decoding is a method for searching for errors in codes and correcting the errors, to thus decode a signal, on the premise that an error arises in all codes with the same possibility. Soft determination decoding is a method for computing the degree of reliability showing the likelihood of a value of a code and correcting errors in codes by use of the degree of reliability, to thus decode a signal.

The number of bits transmitted at one time by one sub-carrier varies according to a modulation method. The modulation method includes QPSK (Quadrature Phase Shift Keying), 8PSK (Phase Shift Keying), 16QAM (Quadrature Amplitude Modulation), 64QAM, and the like.

The inner decoder 250 corrects errors in an inner code of the signal received from the outer decoder 240. The signal received from the outer decoder 240 is encoded by means of a RS (Reed-Solomon) code, an LDPC (Low Density Parity Code), a BCH (Bose Chaudhuri Hockquenghem) code, and the like. The inner decoder 250 performs error correction according to the error correction scheme.

In accordance with the signal output from the outer decoder 240 and the signal output from the inner decoder 250, the iterative control section 260 determines whether to output the signal output from the inner decoder 250 as decoded data or take the signal as reference signal used when equalization processing is again performed.

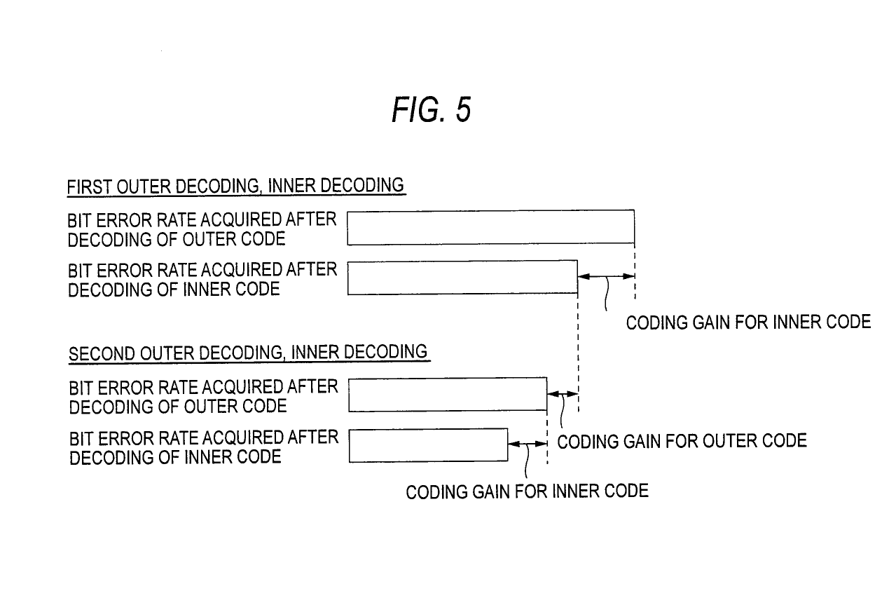

FIG. 5 shows a model chart of a bit error rate of the signal subjected to decoding of an outer code and a bit error rate of the signal subjected to decoding of an inner code obtained when equalization processing, decoding of an outer code, and decoding of an inner code are performed twice.

The bit error rate of the signal subjected to decoding of an inner code first time is smaller than the bit error rate of the signal subjected to decoding of an outer code first time. The reason for this is that the bit error rate is decreased as a result of the inner code decoder 250 subjecting, to error correction, the signal encoded by the code having an error correction function. A reduction in bit error rate corresponds to an encoding gain of the inner code.

The bit error rate of the signal subjected to decoding of an outer code second time is smaller than the bit error rate of the signal subjected to decoding of an inner code first time. The reason for this is that the bit error rate is decreased by equalization processing based on more accurate estimation of a propagation channel extracted from the signal whose bit error rate is decreased and an encoding gain of the outer code.

As mentioned above, a bit error rate of the signal is decreased as a result of repetition of equalization processing, decoding of an outer code, and decoding of an inner code. In the meantime, when an increase arises in the number of times equalization processing, decoding of an outer code, and decoding of an inner code are performed, processing required by receiving operation of the OFDM receiver 1 is increased, whereupon a processing delay increases. Accordingly, the iterative control section 260 determines whether to output the signal output from the inner decoder 250 as received decoded data or take the signal as a reference signal used when equalization processing is performed again, in accordance with a difference between a bit error rate of the signal underwent second previous equalization, second previous decoding of an outer code, and second previous decoding of an inner code and a bit error rate of the signal underwent immediately previous equalization, immediately previous decoding of an outer code, and immediately previous decoding of an inner code; namely, the status of convergence of the bit error rate.

According to a result of determination made by the iterative control section 260, the switching section 270 switches between transmitting the signal whose inner code is decoded by the inner decoder 250 to the equalization processing section 230 in order to be taken as a reference signal when equalization processing is again performed and outputting the signal as decoded data.

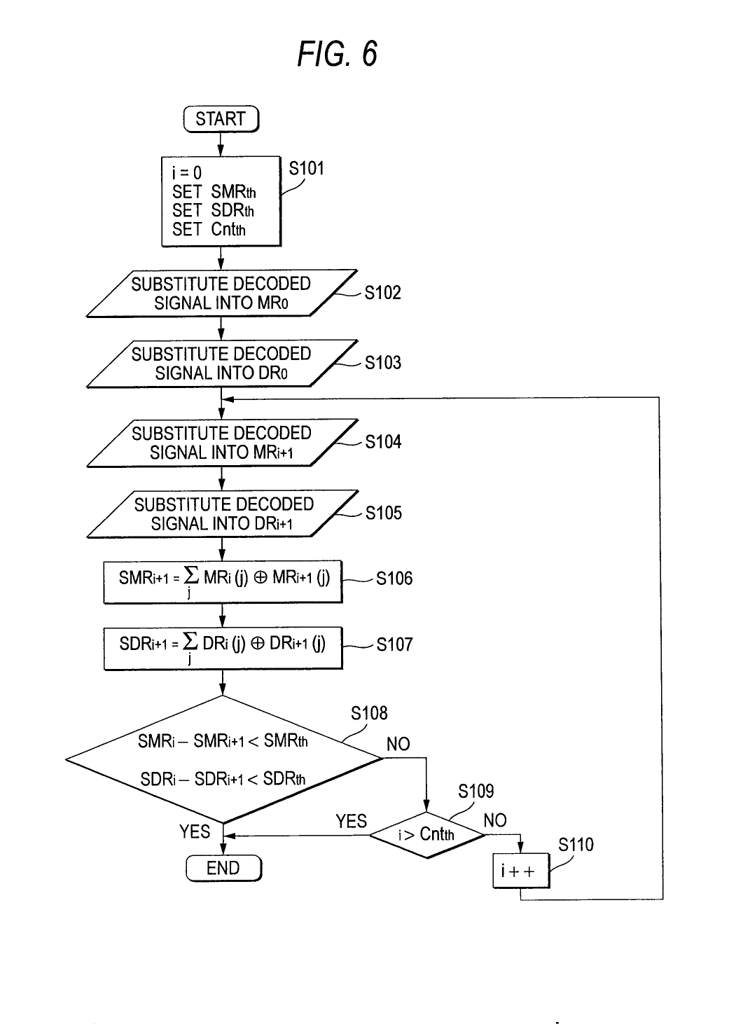

FIG. 6 is a flowchart showing operation of the iterative control section 260.

The iterative control section 260 sets a threshold value “SMRth” of a difference between a signal underwent second previous decoding of an outer code and a signal underwent immediately previous decoding of an outer code and a threshold value “SDRth” of a difference between a signal underwent second previous decoding of an inner code and a signal underwent immediately previous decoding of an inner code, both threshold values being used for determining convergence of a bit error rate. Further, the iterative control section 260 initializes a dummy variable “i” to “0,” thereby setting the maximum number of times “Cntₜₕ” employed when iterative processing is performed (step S101). SMRₜₕ, SDRₜₕ, and Cntₜₕ may also be values previously determined in accordance with the policy and requirement specifications of the OFDM receiver 1 or may also be determined by the user.

Next, the iterative control section 260 receives from the outer decoder 240 the signal underwent first decoding of an outer code, and substitutes the thus-received signal into MRo (step S102). Next, the iterative control section 260 receives from the inner decoder 250 the signal underwent first decoding of an inner code, and substitutes the received signal into DRo (step S103). The iterative control section 260 receives from the outer decoder 240 the signal underwent second decoding of an outer code, and substitutes the thus-received signal into MRᵢ₊₁ (step S104). Subsequently, the repetitive control section 260 receives from the decoder 250 the signal underwent second decoding of an inner code, and substitutes the thus-received signal into MDᵢ₊₁ (step S105).

The iterative control section 260 subjects to exclusive OR processing a bit pertaining to a signal underwent second previous decoding of an outer code and a bit pertaining to a signal underwent immediately previous decoding of an outer code. The number of bits corresponding to “1” in a result of exclusive OR processing is substituted into “SMRᵢ₊₁” (step S106).

The iterative control section 260 subjects to exclusive OR processing a bit pertaining to a signal underwent second previous decoding of an inner code and a bit pertaining to a signal underwent immediately previous decoding of an inner code. The number of bits corresponding to “1” in a result of exclusive OR processing is substituted into “SDRᵢ₊₁” (step S107).

The iterative control section 260 subtracts SMRᵢ₊₁ from SMRi and determines whether or not a result of subtraction is greater than the threshold value SMRₜₕ. Further, the iterative control section 260 subtracts SDRᵢ₊₁ from SDRi and determines whether or not a result of subtraction is greater than the threshold value SDRₜₕ (step S108). A termination condition for determining whether or not the bit error rate acquired in step S108 has converged may also be a case where a change in a result of estimation of a propagation channel performed by the equalization processing section 230 has come to a constant level or less or where the amount of deterioration in ICI arising in the same manner where ICI arises because of compensation for a distortion in the propagation channel and Zero-Padding OFDM has come to a given level or less.

When the two conditions are simultaneously satisfied (YES in step S108), the iterative control section 260 determines that the bit error rate is converged, and iterative processing is terminated.

When the two conditions are not simultaneously satisfied (NO in step S108), the iterative control section 260 then determines whether or not the dummy variable “i” is greater than the threshold value “Cntₜₕ” (step S109).

When the dummy variable “i” is greater than the threshold value “Cntₜₕ” (YES in step S109), the iterative control section 260 determines that the number of iterative operations has surpassed the maximum number, thereby terminating iterative processing.

In the meantime, when the dummy variable “i” is the threshold value “Cntₜₕ” or less (NO in step S109), the iterative control section 260 increments a dummy variable “i” (step S110), to thus iterate processing pertaining to steps S104 through S109.

As mentioned above, in accordance with the signals output from the outer decoder 240 and the inner decoder 250, the iterative control section 260 determines whether or not the signal output from the inner decoder 250 is output as decoded data or taken as a reference signal used when equalization processing is performed again.

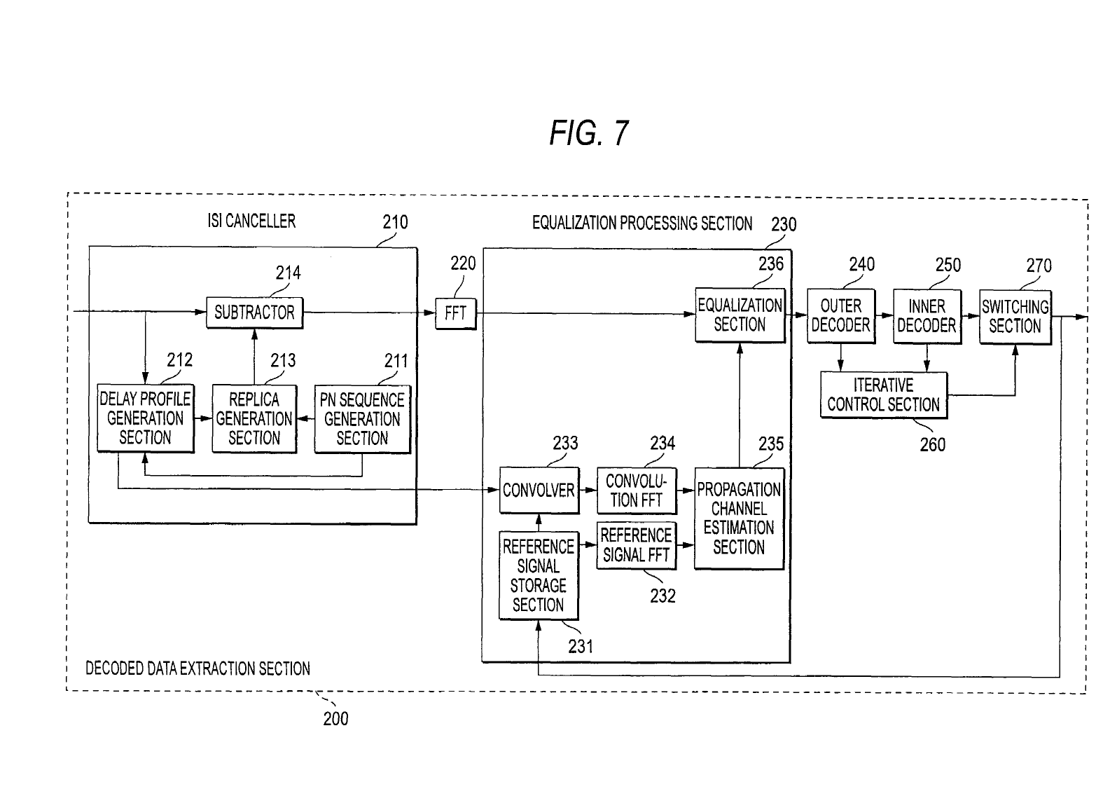

FIG. 7 is a block diagram showing the inner configuration of the ISI canceller 210 and the inner configuration of the equalization processing section 230.

The ISI canceller 210 has a PN sequence generation section 211 for generating a spread code; a delay profile generation section 212 for generating a delay profile by use of a PN sequence generated by the PN sequence generation section 211 and a signal received from the front end section 100; a replica generation section 213 which generates, by use of the delay profile, a replica signal corresponding to leakage of a guard interval portion into the OFDM symbol; and a subtractor 214 which subtracts a replica signal from a signal output from the front end section 100, to thus eliminate ISI.

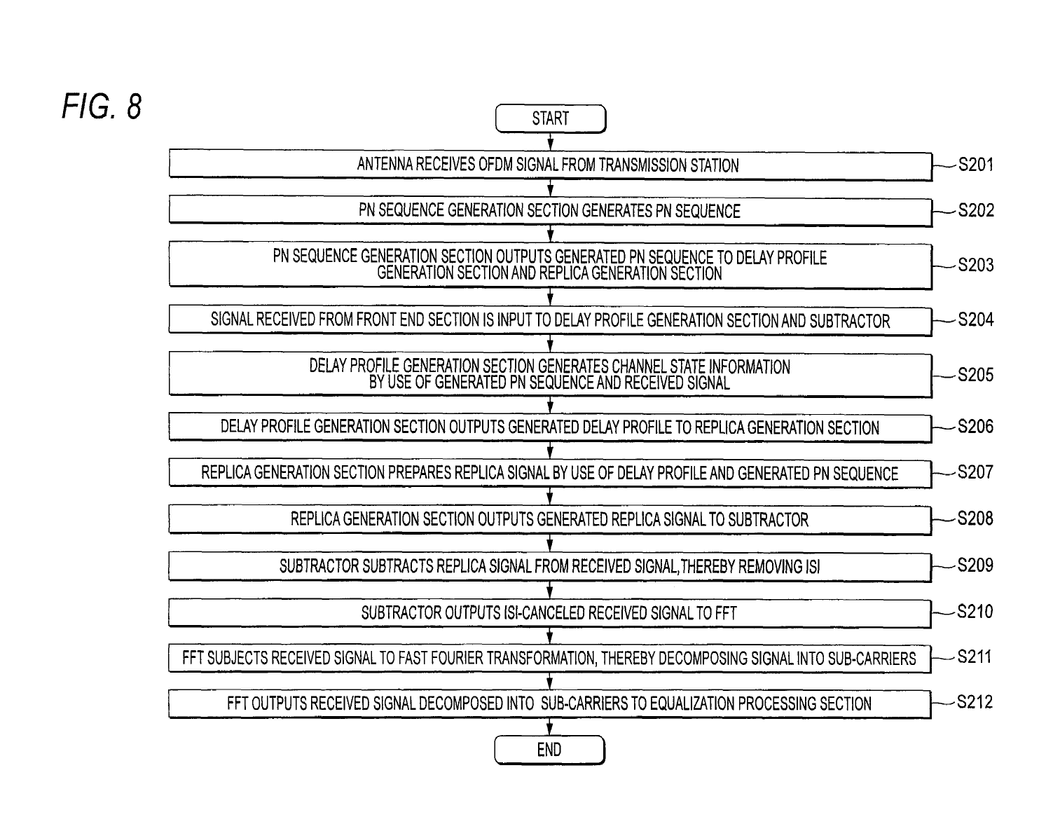

FIG. 8 is a flowchart showing operation of the ISI canceller 210.

First, the antenna 105 of the OFDM receiver 1 receives the OFDM signal from the transmission station (step S201). As mentioned above, the received signal is processed by the front end section 100.

Next, the PN sequence generation section 211 of the ISI canceller 210 generates a PN sequence (step S202). The thus-generated PN sequence is a pseudo random sequence and shows high correlation with a corresponding PN sequence but low correlation with another symbol sequence (e.g., an OFDM symbol) or another PN sequence. The PN sequence generation section 211 generates at a receiving end a PN sequence corresponding to the PN sequence generated at the transmission end.

The PN sequence generation section 211 outputs a generated PN sequence to the delay profile generation section 212 and the replica generation section 213 (step S203).

Next, the signal received from the front end section 100 is output to the ISI canceller 210, and the received signal is input to the delay profile generation section 212 and the subtractor 214 (step S204).

Next, the delay profile generation section 212 generates a delay profile by use of the generated PN sequence output from the PN sequence generation section 211 and the received signal output from the front end section 100 (step S205). The delay profile generation section 212 performs cross correlation of a signal corresponding to a guard interval of the OFDM signal received in accordance with symbol synchronization information about the symbol synchronization section 160 and the PN sequence generated by the PN sequence generation section 211. The delay profile generation section 212 also performs cross correlation of a signal corresponding to a guard interval of an OFDM signal received at the next time and the PN sequence generated by the PN sequence generation section 211. The delay profile generation section 212 iterates such processing, to thus become able to acquire a delay profile which is a characteristic pertaining to a relationship between a delay and a corresponding amplitude and phase, through mutual correlation processing.

A situation where the propagation channel corresponds to a multipath environment will be described by way of example. The antenna 105 receives an OFDM signal traveled through the multipath propagation channel. Accordingly, the delay profile generation section 212 acquires a delay profile corresponding to the state of the propagation channel by means of correlation processing.

The delay profile is information pertaining to relative delay times of the OFDM signals traveled through the multipath propagation channels and amplitudes and phases corresponding to the delay times.

A delay time, an amplitude, and a phase of an OFDM signal first received by the antenna 105; a delay time, an amplitude, and a phase of an OFDM signal second received by the antenna 105; . . . , a delay time, an amplitude, and a phase of an OFDM signal received the n^{th} by the antenna 105 are computed, whereupon a delay profile is determined.

The delay profile generation section 212 performs processing such as that mentioned above, to thus generate a delay profile (e.g., a horizontal axis: a delay time and a vertical axis: a relative complex amplitude level of an amplitude provided of a profile provided at an upper right position of FIG. 4, where a phase is omitted).

The delay profile generation section 212 then outputs the thus-generated delay profile to the replica generation section 213 (step S206).

Next, the replica generation section 213 generates a replica signal by use of a PN sequence output from the PN sequence generation section 211 and a delay profile output from the delay profile generation section 212 (step S207). Specifically, the replica generation section 213 subjects a delay profile and the signal generated by the PN sequence generation section 211 to convolution processing, to thus compute a replica signal corresponding to a leakage of a guard interval portion into the OFDM symbol.

The replica generation section 213 outputs a generated replica signal to the subtractor 214 (step S208).

The subtractor 214 eliminates ISI from a received signal by use of the received signal output from the front end section 100 and the replica signal output from the replica generation section 213 (step S209). Specifically, the subtractor 214 subtracts the replica signal from the received signal. Since the leakage of the guard interval is eliminated from the received signal, interference (ISI) between the OFDM symbol and the guard interval is eliminated.

The subtractor 214 outputs the ISI-canceled signal to an FFT 220 (step S210).

The FFT 220 subjects the ISI-canceled received signal output from the subtractor 214 to fast-Fourier transformation (step S211). Thereby, the FFT 220 decomposes the received signal into sub-carriers.

The FFT 220 outputs the received signal decomposed into sub-carriers to the equalization processing section 230 (step S212). Operation of the ISI canceller 210 will be terminated thus far.

Turning back to descriptions about FIG. 7, the equalization processing section 230 has a reference signal storage section 231 which stores, as a reference signal, a signal output from a previously-determined arbitrary symbol sequence or a signal output from a switching section 270; a reference signal FFT 232 which subjects the reference signal to fast Fourier transformation; a convolver 233 which subjects to convolution processing a delay profile output from the delay profile generation section 212 of the ISI canceller 210 and the reference signal of the delay profile; a convolution FFT 234 which subjects a result of processing performed by the convolver 233 to fast Fourier transformation; a propagation channel estimation section 235 which estimates information (CSI: Channel State Information) showing the state of a propagation channel by use of a result of fast Fourier transformation of the reference signal and a result of fast Fourier transformation of the result of computation performed by the convolver 233; and an equalization section 236 for performing equalization processing by use of the CSI.

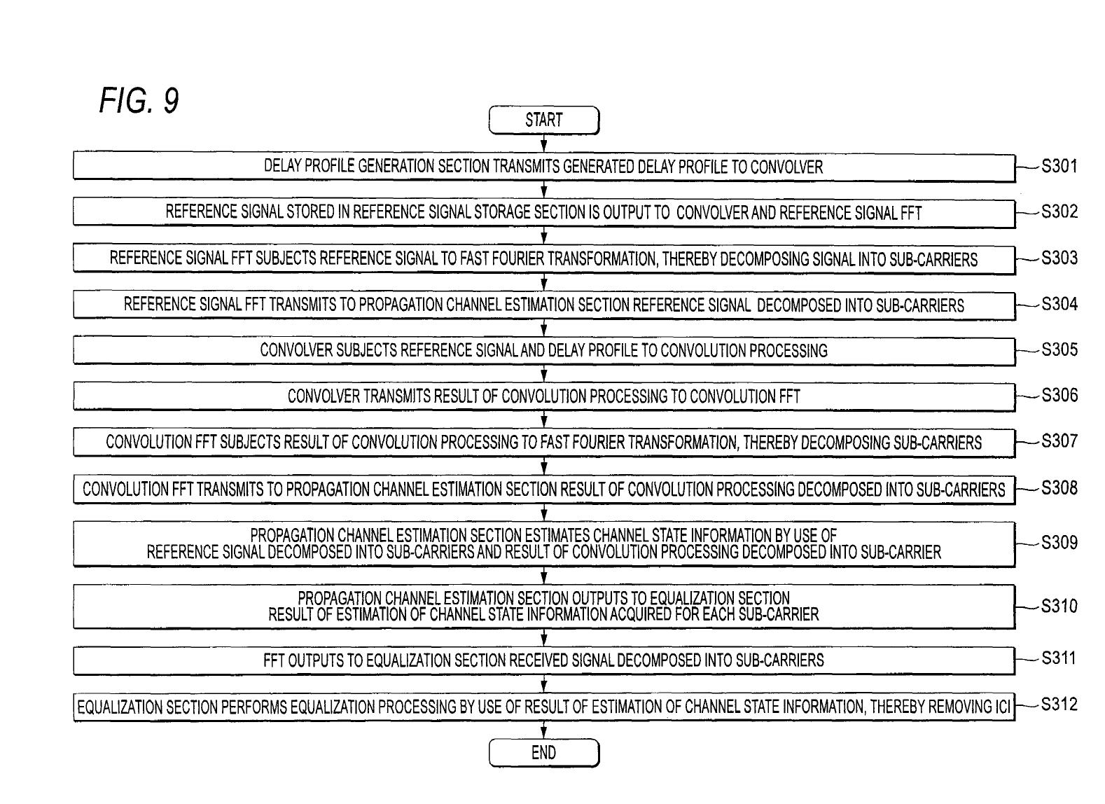

FIG. 9 is a flowchart showing operation of the equalization processing section 230.

First, the delay profile generation section 212 of the ISI canceller 210 outputs a prepared delay profile to the convolver 233 (step S301).

Next, the reference signal stored in the reference signal storage section 231 is output to the convolver 233 and the reference signal FFT 232 (step S302). A predetermined symbol sequence is stored as an initial value in the reference signal storage section 231. The reference signal storage section 231 is updated to a signal obtained through equalization processing, decoding of an outer code, and decoding of an inner code.

The reference signal FFT 232 subjects the reference signal output from the reference signal storage section 231 to fast Fourier transformation, thereby decomposing the signal into sub-carriers (step S303).

The reference signal FFT 232 outputs the reference signal, which has been decomposed into sub-carriers, to the propagation channel estimation section 235 (step S304).

The convolver 233 performs convolution processing of a delay profile output from the delay profile generation section 212 and a reference signal output from the reference signal storage section 231 (step S305). The convolver 233 outputs a result of convolution processing to the convolution FFT 234 (step S306).

The convolution FFT 234 subjects a result of convolution processing output from the convolver 233 to fast Fourier transformation, to thus decompose the result into sub-carriers (step S307). Next, the convolution FFT 234 outputs the result of convolution processing, which has been decomposed into sub-carriers, to the propagation channel estimation section 235 (step S308).

The propagation channel estimation section 235 estimates the state of the channel state information by use of the reference signal decomposed into sub-carriers and the result of convolution processing decomposed into sub-carriers (step S309). Specifically, the propagation channel estimation section 235 subjects the result of convolution processing decomposed into sub-carriers to complex division by means of the reference signal, thereby estimating the state of the channel state information from the sub-carriers. The propagation channel estimation section 235 outputs a result of estimation of the state of the channel state information (a result of estimation of the channel state information) to the equalization section 236 (step S310).

The FFT 220 outputs the received signal decomposed into sub-carriers to the equalization section 236 of the equalization processing section 230 (step S311).

The equalization section 236 performs equalization processing by use of the received signal which is output from the FFT 220 and decomposed into the sub-carriers and the result of estimation of channel state information in compliance with the sub-carriers received from the propagation channel estimation section 235, thereby eliminating ICI and compensating for distortion in the propagation channels (step S312).

Provided that Y designates a receipt signal received by the antenna 105; H designates the state of a propagation channel (a result of estimation of a propagation channel); and X designates a transmission signal transmitted from the transmission station, a relational expression of Y=HX stands, where X, Y, and H correspond to vectors. Since Y is determined accurately, the accuracy of X depends on the accuracy of H. Accordingly, in connection with equalization processing, the more the result H of estimation of a propagation channel is accurate, removal of ICI and compensation for distortion in the propagation channel are performed accurately.

As shown in FIG. 5, as equalization processing, decoding of an outer code, and decoding of an inner code are repeated, the bit error rate of the signal decreases. Specifically, the signal (information) “X” transmitted from the transmission station is be determined more accurately. Therefore, the equalization processing section 230 accurately performable removal of ICI from the received signal and compensation for distortion in the propagation channel as equalization processing, decoding of an outer code, and decoding of an inner code are repeated.

As mentioned above, according to the OFDM receiver 1 of the first embodiment, the bit error rate of the OFDM signal received by the antenna 105 is reduced by repetition of equalization processing, decoding of an outer code, and decoding of an inner code, so that receiving quality is enhanced.

In order to prepare a delay profile of the propagation channel from the guard interval, the amount of processing incident to preparation of a delay profile and estimation of a propagation channel from the delay profile is reduced, whereupon a processing delay is lightened.

Since ISI resulting from leakage of the guard interval into the OFDM symbol and ISI resulting from elimination of the guard interval is corrected, the length of the guard interval is shortened. Enhancement of a data transfer rate is realized. Moreover, even in a propagation channel where the delay time exceeds a guard interval, deterioration of receiving quality is lessened.

The decoded data extraction section 200 of the OFDM receiver 1; namely, the ISI canceller 210, the FFT 220, the equalization processing section 230, the outer decoder 240, the inner decoder 250, the iterative control section 260, and the switching section 270, is implemented as hardware by means of; for example, a semiconductor integrated circuit.

The decoded data extraction section 200 of the OFDM receiver 1 also is implemented by use of; for example, a general-purpose computer as basic hardware. Specifically, the ISI canceller 210, the FFT 220, the equalization processing section 230, the outer decoder 240, the inner decoder 250, the switching section 270, and the iterative control section 260 is implemented by means of causing a processor provided in the computer to execute a program. At this time, the decoded data extraction section 200 of the OFDM receiver 1 may also be implemented by means of installing the program in the computer in advance. Alternatively, the program may also be installed in a computer, as required, by storing the program in a storage medium, such as CD-ROM, or distributing the program by way of a network, to thus implement the decoded data extraction section.

### Second Embodiment

A second embodiment differs from the first embodiment in that two antennas are provided, to thus realize a diversity configuration. In the case of an actual propagation channel, distortion originating from a multipath arises in the propagation channel. Further, chronological variations (a Doppler shift and a Doppler spread), or the like, in a propagation channel, which arise in a case where relative movement exists between the transmission station and the receiving station, are entailed. In such a propagation channel, there arises a case where, when a received waveform is observed along a frequency axis or a time axis, significant fluctuations arise in receiving power for reasons of distortion in the propagation channel.

Therefore, uncorrectable errors often arise in the signal received by the antenna. However, when there is adopted a configuration for receiving radio waves by means of a plurality of antennas, another antenna receivable a signal even if an uncorrectable error arises in the signal received by one antenna. A technique for constituting a device for receiving radio waves from a plurality of antennas is called diversity.

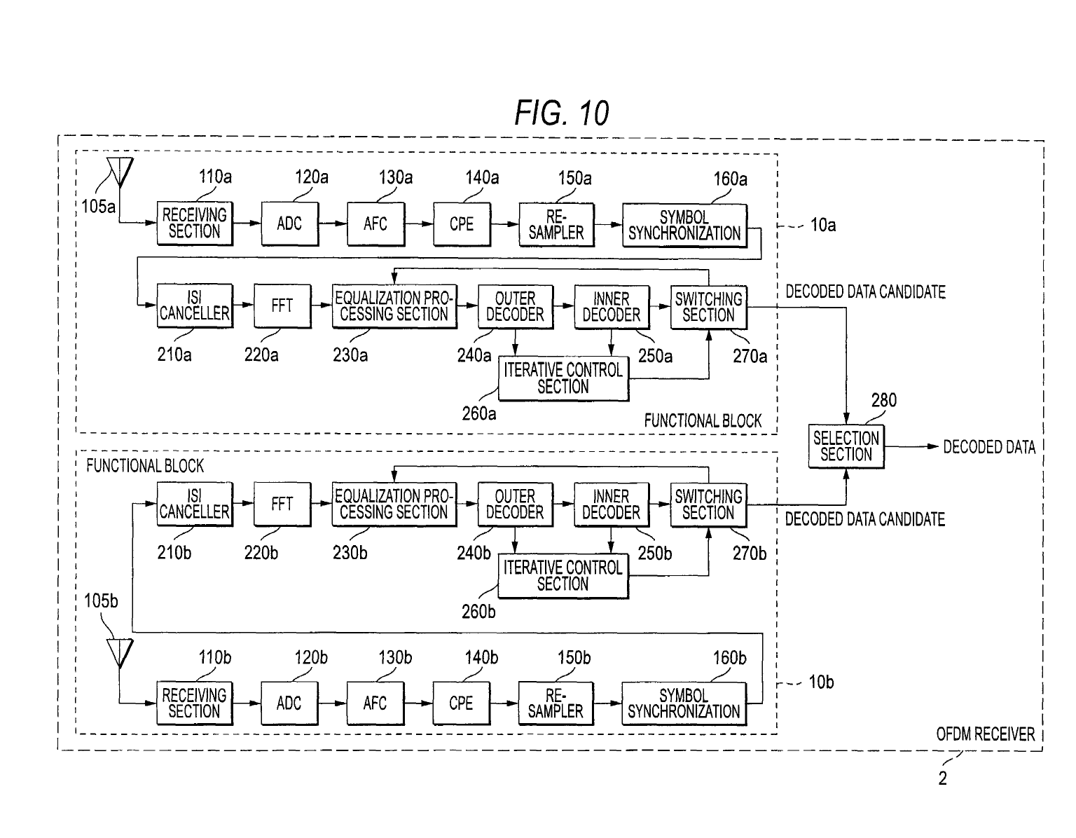

FIG. 10 is a block diagram showing the configuration of the OFDM receiver 2 of the second embodiment.

The OFDM receiver 2 of the second embodiment has a functional block 10a including an antenna 105a, a receiving section 110a, an ADC 120a, an AFC 130a, a CPE 140a, a re-sampler 150a, a symbol synchronization section 160a, an ISI canceller 210a, an FFT 220a, an equalization processing section 230a, an outer decoder 240a, an inner decoder 250a, an iterative control section 260a, and a switching section 270a. The OFDM receiver 2 of the second embodiment has a functional block 10b including an antenna 105b, a receiving section 110b, an ADC 120b, an AFC 130b, a CPE 140b, a re-sampler 150b, a symbol synchronization section 160b, an ISI canceller 210b, an FFT 220b, an equalization processing section 230b, an outer decoder 240b, an inner decoder 250b, an iterative control section 260b, and a switching section 270b. The OFDM receiver 2 of the second embodiment has a selection section 280 for selecting any one of outputs from the switching sections 270a and 270b of the two functional blocks 10a and 10b. Explanation of elements which operate in the same manner the OFDM receiver 1 of the first embodiment is omitted hereunder.

Signals received by the antennas 105a and 105b are subjected to receiving processing in the respective functional blocks 10a and 10b. The received signals are output by the switching sections 270a and 270b to the selection section 280 as a candidate for decoded data. The switching sections 270a and 270b output to the selection section 280 results of estimation of a propagation channel performed by propagation channel estimation sections (not shown) of the equalization processing sections 230a and 230b of the respective functional blocks 10a and 10b.

The selection section 280 then selects, from the two decoded data candidates, a decoded data candidate received from the functional block for which the result of estimation of a propagation channel having a larger absolute value is received; and outputs the selected decoded data candidate as decoded data.

As mentioned above, according to the OFDM receiver 2 of the second embodiment, the diversity configuration for receiving radio waves by means of the two antennas 105a and 105b is adopted. As a result, even in a propagation environment where distortion arises, occurrence of an uncorrectable error is prevented, thereby preventing deterioration of receiving quality.

Moreover, a bit error rate of the OFDM signal received by the antenna is diminished by repetition of equalization processing, decoding of an outer code, and decoding of an inner code, thereby enhancing receiving quality.

The OFDM receiver 2 of the second embodiment is configured so as to have three functional blocks which are the same in configuration with the OFDM receiver 1 of the first embodiment. At this time, the OFDM receiver 2 of the second embodiment has a selection section for selecting any one from the decoded data candidates from the three functional blocks. The selection section determines bits of data output from the three functional blocks according to a majority rule, and obtained data may also be output as decoded data. The OFDM receiver 2 of the second embodiment is configured so as to include four or more functional blocks which are identical in configuration with the OFDM receiver 1 of the first embodiment.

### Third Embodiment

The decoded data candidates from the respective functional blocks 10a and 10b of the OFDM receiver 2 of the second embodiment are taken as reference signals used when the respective equalization processing sections 230a and 230b estimate propagation channels. In addition, for instance, the decoded data output by the selection section 280 is taken as a reference signal used when the respective equalization processing sections 230a and 230b estimate propagation channels.

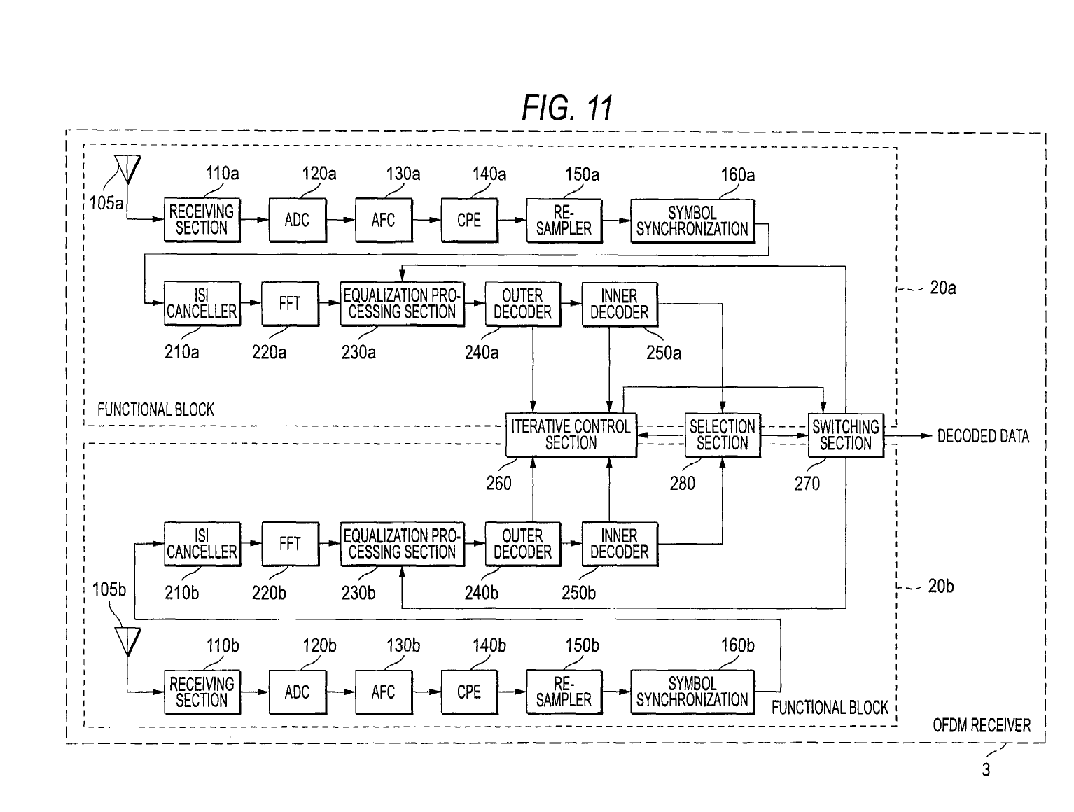

FIG. 11 is a block diagram showing the configuration of the OFDM receiver 3 of the third embodiment.

The OFDM receiver 3 of the third embodiment has a functional block 20a including the antenna 105a, the receiving section 110a, the ADC 120a, the AFC 130a, the CPE 140a, the re-sampler 150a, the symbol synchronization section 160a, the ISI canceller 210a, the FFT 220a, the equalization processing section 230a, the outer decoder 240a, and the inner decoder 250a. The OFDM receiver 3 of the third embodiment has a functional block 20b including the antenna 105b, the receiving section 110b, the ADC 120b, the AFC 130b, the CPE 140b, the re-sampler 150b, the symbol synchronization section 160b, the ISI canceller 210b, the FFT 220b, the equalization processing section 230b, the outer decoder 240b, and the inner decoder 250b. The OFDM receiver 3 of the third embodiment has the iterative control section 260, the switching section 270, and the selection section 280, which are common to the two functional blocks 20a and 20b. Explanation of elements which operate in the same manner the OFDM receiver 1 of the first embodiment is omitted hereunder. Moreover, since the selection section 280 operates in the same manner as does the OFDM receiver 2 of the second embodiment, an explanation thereof is omitted likewise.

Signals received by the antennas 105a and 105b are subjected to receiving processing in the respective functional blocks 20a and 20b. The selection section 280 selects any one of signals output from the decoders 250a and 250b of the respective functional blocks 20a and 20b, and outputs the thus-selected signal to the switching section 270 and the iterative control section 260. Next, the iterative control section 260 determines whether or not the bit error rate of the signal received from the selection section 280 is converged, thereby determining whether or not iterative processing is performed. The iterative control section 260 outputs the result of determination to the switching section 270.

In accordance with a result of determination received from the iterative control section 260, the switching section 270 outputs the signal received from the selection section 280 as decoded data or stores the thus-received signal in a reference signal storage section (not shown) as a reference signal used when the equalization processing sections 230a and 230b of the functional blocks 20a and 20b estimate propagation channels.

As mentioned above, the OFDM receiver 3 of the third embodiment is configured as a diversity receiver which receives a radio wave by means of the two antennas 105a and 105b. The decoded signal having a small error rate selected by the selection section 280 is taken as a reference signal used when the equalization processing sections 230a and 230b estimate propagation channels. As a result, the speed of reduction of the bit error rate becomes larger, and the bit error rate is converged by means of a smaller number of iterations. Thus, the processing delay is shortened.

Even in the propagation environment where distortion arises in the propagation channel, occurrence of an uncorrectable error is prevented, and deterioration of receiving quality is prevented.

Moreover, equalization processing, decoding of an outer code, and decoding of an inner code are iteratively performed, so that the bit error rates of the OFDM signals received by the antennas 105a and 105b is reduced, so that receiving quality is enhanced.

The OFDM receiver 3 of the third embodiment is configured so as to have three or more functional blocks which are equal in configuration to the OFDM receiver 1 of the first embodiment and the OFDM receiver 2 of the second embodiment.

### Fourth Embodiment

In order to realize a diversity configuration for receiving radio waves by means of the two antennas 105a and 105b, the OFDM receiver 2 of the second embodiment processes the signals received by the antennas 105a and 105b respectively in the functional blocks 20a and 20b. In addition, two signals received by the two antennas 105a and 105b are combined, and the thus-combined signal is processed.

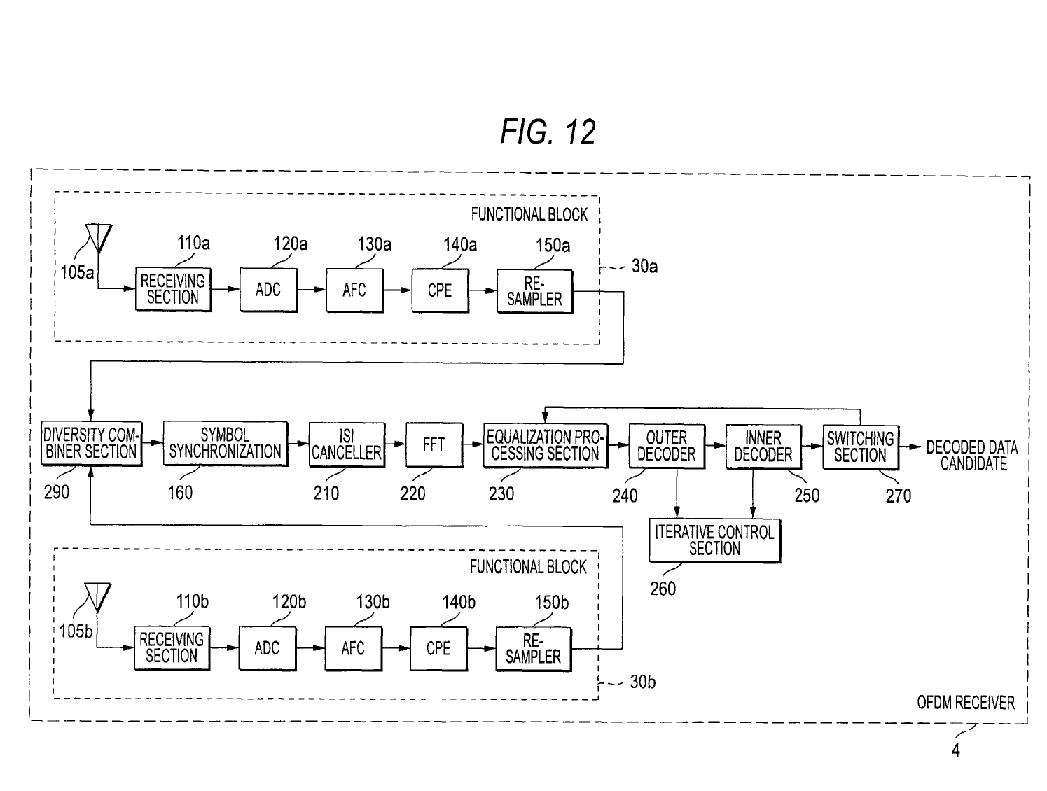

FIG. 12 is a block diagram showing the configuration of the OFDM receiver 4 of the fourth embodiment.

The OFDM receiver 4 of the fourth embodiment has a functional block 30a including the receiving section 110a, the ADC 120a, the AFC 130a, the CPE 140a, and the re-sampler 150a. Moreover, the OFDM receiver 4 of the fourth embodiment has a functional block 30b including the receiving section 110b, the ADC 120b, the AFC 130b, the CPE 140b, and the re-sampler 150b. The OFDM receiver 4 of the fourth embodiment has a diversity combiner section 290 for combining signals output from the two functional blocks 30a and 30b. Further, the OFDM receiver 4 of the fourth embodiment has the symbol synchronization section 160, the ISI canceller 210, the FFT 220, the equalization processing section 230, the outer decoder 240, the inner decoder 250, the switching section 270, and the iterative control section 260. Explanation of elements which operate in the same manner the OFDM receiver 1 of the first embodiment is omitted hereunder.

First, each of the functional blocks 30a and 30b receives a radio wave, and receipt processing of the radio waves is performed. Next, the diversity combiner section 290 receives signals output from the re-samplers 150a and 150b of the respective functional blocks 30a and 30b, thereby combining the two signals.

The method pertaining to combination processing performed by the diversity combiner section 290 includes maximal ratio combination, equivalent gain combination, selective combination, or the like. Further, the method includes a method for reducing a disturbing wave, such as an interference wave. Moreover, the diversity combiner section 290 is applicable such a combination processing method to frequency domains of signals to be combined, time domains of the same, or both time and frequency domains of the signals to be combined. Moreover, processing for combining a frequency domain, a time domain, and a space domain merged with space signal processing utilizing a plurality of antennas, such as array antennas or adaptive array antennas, is applicable.

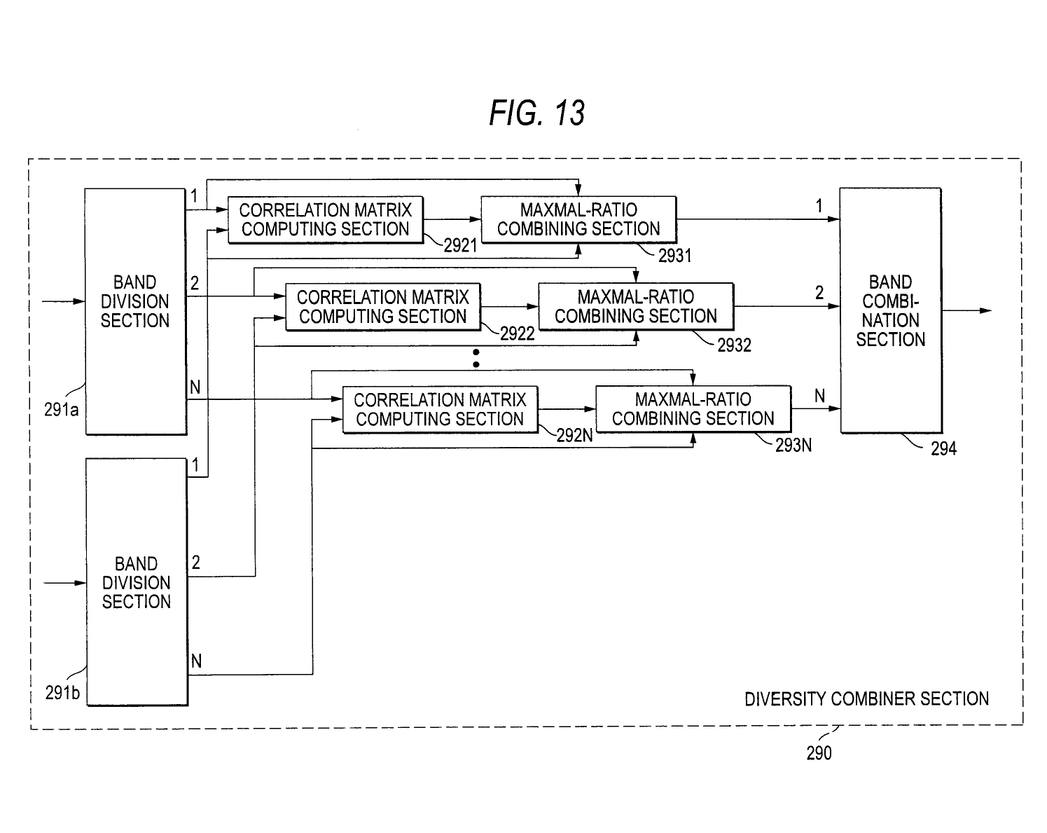

FIG. 13 is a block diagram showing constituent sections of the combination section diversity of the fourth embodiment. The diversity combiner section 290 is described in connection with, by way of example, combination of two received signals at the maximal ratio.

The diversity combiner section 290 of the fourth embodiment has band division sections 291a and 291b which split received signals output from the two functional blocks 30a and 30b into N (N is an integer of two or more) bands; N correlation matrix computing sections 2921, 2922, . . . , 292N for computing correlation matrices of respective received signals split by the band division sections 291a and 291b; N maximal-ratio combining sections 2931, 2932, . . . 293N for performing combination of signals at the maximal ratio by use of computing results performed by the correlation matrix computing sections 2921, 2922, . . . 292N and the received signals split by the band division sections 291a and 291b; and a band combination section 294 which receives computing results of the N maximal-ratio combining sections 2931, 2932, . . . 293N, to thus combine bands.

First, the functional blocks 30a and 30b subject the signals received by the two antennas 105a and 105b to frequency conversion processing and re-sampling. Next, the band division section 291 receives a signal from the re-sampler 150 of the corresponding functional block. The band division sections 291a and 291b then split the received signals into N frequency bands.

The correlation matrix computing sections 2921, 2922, . . . , 292N receive the signals split by the band division sections 291a and 291b and subject the thus-received signals to correlation matrix computing. Next, The maximal-ratio combining sections 2931, 2932, . . . , 293N perform maximal-ratio combination by use of characteristic vectors belonging to the maximum characteristic values which are results of computation of the correlation matrix sections 2921, 2922, . . . , 292N and the received signals split by the band division sections 291a and 291b. Provided that a signal received by one antenna 105a is taken as Y₁; that the state of a propagation channel between a master station and the antenna 105a is taken as H₁; that a signal received by the other antenna 105b is taken Y₂; and that the state of a propagation channel between the master station and the antenna 105b is taken as H₂, the signal underwent maximal-ratio combination is defined as

[symbol]

The band combination section 294 combines the signals which are split by the band division sections 291a and 291b and which has been subjected to maximal-ratio combination by means of the N maximal-ratio combining sections 2931, 2932, . . . , 293N. The diversity combiner section 290 combines the signals received from the antennas 105a and 105b.

As mentioned above, the OFDM receiver 4 of the fourth embodiment is formed so as to have a diversity configuration which receives radio waves by means of the two antennas 105a and 105b. The signals received by the antennas are combined together, thereby enhancing an SNR (Signal-to-Noise Ratio) of the received signal and reducing an error rate of the received signal.

According to the OFDM receiver 4 of the fourth embodiment, although the diversity configuration for receiving radio waves by means of the two antennas 105a and 105b is realized, the OFDM receiver does not need to include, in number of two, the symbol synchronization section 160, the ISI canceller 210, the FFT 220, the equalization processing section 230, the outer decoder 240, the inner decoder 250, the switching section 270, and the iterative control section 260. Thus, a circuit scale is reduced.

Moreover, equalization processing, decoding of an outer code, and decoding of an inner code are performed iteratively, whereby the bit error rate of the OFDM signal received by the antennas is reduced, and receiving equality is enhanced.

The present invention is not limited, in unmodified form, to the embodiments. In a practical phase, the present invention is embodied by means of modification of the constituent elements within the scope of the invention. Various inventions is created by appropriate combinations of the plurality of constituent elements described in the embodiments. For instance, several constituent elements may also be deleted from all of the constituent elements described in the embodiments. Moreover, the constituent elements of the different embodiments may also be combined together as appropriate.

As described with reference to the embodiment, there is provided a wireless receiver which enables enhancement of receiving quality by correctly estimating a propagation channel, to thus reduce a bit error rate of a received signal, in a propagation environment where a sight line, such as an LOS, from a transmission station to a receiving station is acquired and a propagation environment where no sight line, such as NLOS (Non-line Of Sight), from a transmission station to a receiving station is acquired, in connection with a system using a unique word as a guard interval; a method for controlling the wireless receiver; a program for controlling the wireless receiver; and a semiconductor integrated circuit.

That is, According to the above embodiment, there is provided a wireless receiver that a propagation channel is correctly estimated in a propagation environment where a sight line, such as an LOS, from a transmission station to a receiving station is acquired and a propagation environment where no sight line, such as NLOS (Non-line Of Sight), from a transmission station to a receiving station is acquired, in connection with a system using a unique word as a guard interval. Thereby, a bit error rate of a received signal is reduced, thereby enhancing receiving quality.

What is claimed is:

1. A wireless receiving apparatus comprising:
an antenna that receives an OFDM (Orthogonal Frequency Division Multiplexing) signal transmitted from a wireless transmitter, the OFDM signal having an OFDM symbol and a guard interval;
a front end section that performs frequency conversion and synchronization on the received OFDM signal;
an ISI (Inter-Symbol Interference) canceller that extracts a delay profile from a signal output from the front end section and removes leakage of the guard interval into the OFDM symbol from the signal output from the front end section by the use of the delay profile;
a converter that performs orthogonal conversion on the ISI removed OFDM signal;
an equalization section that performs equalization processing on the converted OFDM signal by estimating a state of a propagation channel from a reference signal and the delay profile;
an outer decoder that decodes the equalized OFDM signal; and
an inner decoder that corrects an error in an inner code of the decoded OFDM signal,
wherein the equalization section performs re-equalization processing on the converted OFDM signal by using a signal output from the inner decoder as the reference signal.

2. The apparatus according to claim 1, wherein the equalization section performs the re-equalization processing a plurality of times.

3. The apparatus according to claim 2, further comprising:
a control section that determines whether the equalization section performs the re-equalization processing again by comparing current output and previous output from the outer decoder.

4. The apparatus according to claim 1, wherein the guard interval includes PN series.

5. A wireless receiving apparatus comprising:
a first antenna that receives an OFDM (Orthogonal Frequency Division Multiplexing) signal transmitted from a wireless transmitter, the OFDM signal having an OFDM symbol and a guard interval;
a second antenna that receives an OFDM (Orthogonal Frequency Division Multiplexing) signal transmitted from a wireless transmitter, the OFDM signal having an OFDM symbol and a guard interval;
a first front end section that performs frequency conversion and synchronization on the received OFDM signal;
a second front end section that performs frequency conversion and synchronization on the received OFDM signal;
a first ISI (Inter-Symbol Interference) canceller that extracts a delay profile from a signal output from the first front end section and removes leakage of the guard interval into the OFDM symbol from the signal output from the first front end section by the use of the delay profile;
a second ISI (Inter-Symbol Interference) canceller that extracts a delay profile from a signal output from the second front end section and removes leakage of the guard interval into the OFDM symbol from the signal output from the second front end section by the use of the delay profile;
a first converter that performs orthogonal conversion on the ISI removed OFDM signal output from the first ISI canceller;
a second converter that performs orthogonal conversion on the ISI removed OFDM signal output from the second ISI canceller;
a first equalization section that performs equalization processing on the converted OFDM signal output from the first converter by estimating a state of a propagation channel from a first reference signal and the delay profile;
a second equalization section that performs equalization processing on the converted OFDM signal output from the second converter by estimating a state of a propagation channel from a second reference signal and the delay profile;
a first outer decoder that decodes the equalized OFDM signal output by the first equalization section;
a second outer decoder that decodes the equalized OFDM signal output by the second equalization section;
a first inner decoder that corrects an error in an inner code of the OFDM signal decoded by the first outer decoder;
a second inner decoder that corrects an error in an inner code of the OFDM signal decoded by the second outer decoder; and
a selection unit that selects one of outputs from the first inner decoder and the second inner decoder to output as decode data;
wherein the first equalization section performs re-equalization processing on the converted OFDM signal by using a signal output from the first inner decoder as the first reference signal; and
wherein the second equalization section performs re-equalization processing on the converted OFDM signal by using a signal output from the second inner decoder as the second reference signal.

6. The apparatus according to claim 5, further comprising:
a feedback selector that receives the decode data from the selection unit to provide the decode data as the first reference signal to the first equalization section and as the second reference signal to the second equalization section.

7. A method for controlling a wireless receiver comprising:
receiving an OFDM (Orthogonal Frequency Division Multiplexing) signal, the OFDM signal having an OFDM symbol and a guard interval;
performing frequency conversion and synchronization on the received OFDM signal;
extracting a delay profile from a signal obtained by frequency conversion and synchronization;
removing leakage of the guard interval into the OFDM symbol from the signal obtained by frequency conversion and synchronization by the use of the delay profile;
performing orthogonal conversion on the leakage removed OFDM signal;
performing equalization processing on the orthogonal converted OFDM signal by estimating a state of a propagation channel from a reference signal and the delay profile;
decoding the equalized OFDM signal;
correcting an error in an inner code of the decoded OFDM signal; and
performing re-equalization processing on the converted OFDM signal by using the corrected ODFM signal as the reference signal.

8. The method according to claim 7,
wherein the decoding step, the correcting step and the step of performing re-equalization processing are repeatedly performed.
